(19) United States
(12) Patent Application Publication
(10) Pub. No.: US 2026/0275105 A1
(43) Pub. Date: Sep. 17, 2026

(54) POLYCARBONATE RESIN COMPOSITION

(71) Applicant: IDEMITSU KOSAN CO.,LTD., Tokyo (JP)

(72) Inventors: Miya HASHIMOTO, Tokyo (JP); Keisuke YAMANE, Tokyo (JP); Yusuke AOKI, Tokyo (JP)

(73) Assignee: IDEMITSU KOSAN CO.,LTD., Tokyo (JP)

(21) Appl. No.: 19/469,307

(22) PCT Filed: Mar. 7, 2024
(86) PCT No.: PCT/JP2024/008677

§ 371 Date: Sep. 25, 2025

(30) Foreign Application Priority Data
Mar. 31, 2023 (JP) 2023-059239

(51) Int. Cl. C08L 69/00; C08K 5/134; C08K 5/1515; C08K 5/3445; C08K 5/524; G02B 1/04

(52) U.S. Cl. CPC C08L 69/00; C08K 5/134; C08K 5/1515; C08K 5/3445; C08K 5/524; G02B 1/04; C08K 2201/014; C08L 2201/10

(57) ABSTRACT

A polycarbonate resin composition in accordance with an aspect of the present disclosure contains, with respect to 100 parts by mass of a polycarbonate resin, not less than 0.01 parts by mass and not more than 5 parts by mass of an acrylic light diffusion agent, not less than 0.005 parts by mass and not more than 2 parts by mass of a phosphorus-based antioxidant, not less than 0.005 parts by mass and not more than 2 parts by mass of a phenol-based antioxidant, and not less than 0.001 parts by weight and not more than 5 parts by weight of an alicyclic epoxy compound.

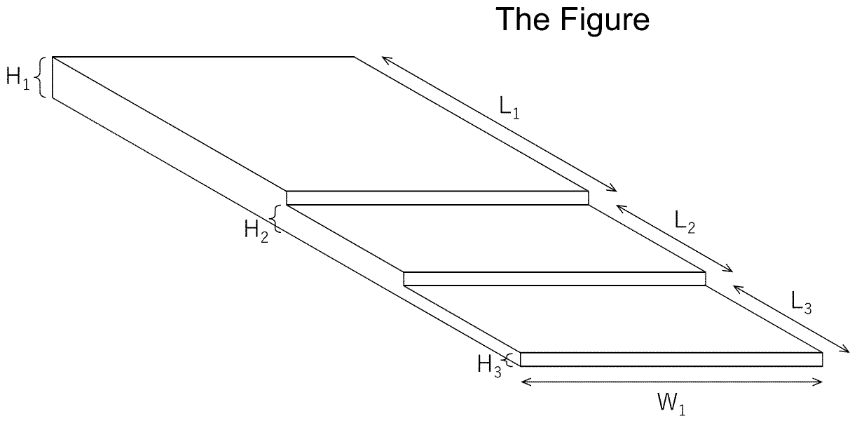

### CROSS-REFERENCE TO RELATED APPLICATIONS

The present application claims priority under 35 U.S.C. § 371 to International Patent Application No. PCT/JP2024/008677, filed Mar. 7, 2024, which claims priority to and the benefit of Japanese Patent Application No. 2023-059239, filed on Mar. 31, 2023. The contents of these applications are hereby incorporated by reference in their entireties.

### TECHNICAL FIELD

The present invention relates to a polycarbonate resin composition.

### BACKGROUND ART

Patent Literature 1 discloses a light diffusive aromatic polycarbonate resin composition containing, with respect to 100 parts by weight of an aromatic polycarbonate resin (A component), (B) 0.05 parts by weight to 2.0 parts by weight of polymer microparticles (B component) and (C) 0.0001 parts by weight to 0.5 parts by weight of a thermal stabilizer (C component), the polymer microparticles (B component) having a refractive index of 1.495 to 1.504. It is indicated that the light diffusive aromatic polycarbonate resin composition disclosed in Patent Literature 1 has both impact resistance that a polycarbonate resin originally has and suitable light diffusivity.

### CITATION LIST

### Patent Literature

[Patent Literature 1]

### Japanese Patent Application Publication Tokukai No.

2011-57925

### SUMMARY OF INVENTION

### Technical Problem

An acrylic light diffusion agent is sometimes employed as a light diffusion agent to be added to a polycarbonate resin composition. This is because the acrylic light diffusion agent has excellent optical characteristics (e.g., light diffusivity and luminous transmittance). However, since the acrylic light diffusion agent has a lower heat resistance temperature than a polycarbonate resin, the acrylic light diffusion agent is thermally decomposed by heat during kneading and molding of a resin composition, so that a volatile organic compound (VOC) such as methyl methacrylate is emitted. Since the VOC is harmful to a human body, a small amount of VOC is desired to be emitted from the resin composition. However, emission of a VOC is not examined for the light diffusive aromatic polycarbonate resin composition of Patent Literature 1.

An aspect of the present invention has an object to provide a novel polycarbonate resin composition that emits a smaller amount of VOC.

### Solution to Problem

The inventors of the present invention carried out diligent studies in order to attain the object, and, as a result, arrived at the present invention by finding for the first time that a polycarbonate resin composition which emits a smaller amount of VOC is obtained by combining and mixing a phosphorus-based antioxidant, a phenol-based antioxidant, and an alicyclic epoxy compound in prescribed amounts with a polycarbonate resin composition containing an acrylic light diffusion agent. That is, a polycarbonate resin composition in accordance with an aspect of the present invention is configured to contain, with respect to 100 parts by mass of a polycarbonate resin, not less than 0.01 parts by mass and not more than 5 parts by mass of an acrylic light diffusion agent, not less than 0.005 parts by mass and not more than 2 parts by mass of a phosphorus-based antioxidant, not less than 0.005 parts by mass and not more than 2 parts by mass of a phenol-based antioxidant, and not less than 0.001 parts by weight and not more than 5 parts by weight of an alicyclic epoxy compound.

### Advantageous Effects of Invention

An aspect of the present invention makes it possible to provide a novel polycarbonate resin composition that emits a smaller amount of VOC.

### BRIEF DESCRIPTION OF DRAWINGS

The FIGURE is a perspective view illustrating an appearance of a molded body produced in Examples.

### DESCRIPTION OF EMBODIMENTS

The following description will discuss an aspect of the present invention in detail. Any numerical range expressed as “A to B” herein means “not less than A (A or more) and not more than B (B or less)” unless otherwise specified. Acrylate or methacrylate is denoted as (meth)acrylate. Similarly, acryl or methacryl is denoted as (meth)acryl.

### <1. Polycarbonate Resin Composition>

### Overview

A polycarbonate resin composition in accordance with an aspect of the present invention (hereinafter, sometimes abbreviated merely as “resin composition”) contains, with respect to 100 parts by mass of a polycarbonate resin, not less than 0.01 parts by mass and not more than 5 parts by mass of an acrylic light diffusion agent, not less than 0.005 parts by mass and not more than 2 parts by mass of a phosphorus-based antioxidant, not less than 0.005 parts by mass and not more than 2 parts by mass of a phenol-based antioxidant, and not less than 0.001 parts by weight and not more than 5 parts by weight of an alicyclic epoxy compound. Aspects of the resin composition in accordance with an aspect of the present invention include: an aspect of a formulation containing raw materials of the resin composition containing the foregoing components; and an aspect of a kneaded mixture obtained by melt-kneading the formulation.

By containing the phosphorus-based antioxidant, the phenol-based antioxidant, and the alicyclic epoxy compound in the above prescribed amounts, the resin composition in accordance with an aspect of the present invention is a polycarbonate resin composition that emits a smaller amount of VOC.

Such a resin composition can be suitably used as a material of any article such as automobile interior parts in which the amount of VOC is strictly defined. Such an effect also contributes to, for example, achievement of Goal 3 “Ensure healthy lives and promote well-being for all at all ages”, Goal 12 “Ensure sustainable consumption and production patterns”, etc. of Sustainable Development Goals (SDGs) proposed by the United Nations.

From a result of a test of addition of a phosphorus-based antioxidant and a phenol-based antioxidant to a polycarbonate resin (shown in Examples described later), the inventors estimate, as below, mechanisms of action of the phosphorus-based antioxidant and the phenol-based antioxidant in reduction of the amount of VOC emitted. It is considered that the phosphorus-based antioxidant prevents emission of radicals in polycarbonate (PC) and that the phenol-based antioxidant traps radicals emitted from PC. Thus, the phosphorus-based antioxidant and the phenol-based antioxidant use different mechanisms of action to prevent radicals emitted from PC from acting on the acrylic light diffusion agent. As a result, a VOC such as methyl methacrylate (MMA) is estimated to be emitted from the acrylic light diffusion agent in a smaller amount.

In contrast, a mechanism of action of the alicyclic epoxy compound in reduction of the amount of VOC emitted is unclear. However, the amount of VOC emitted is further reduced by using the alicyclic epoxy compound in combination with the phosphorus-based antioxidant and the phenol-based antioxidant. Thus, the alicyclic epoxy compound is considered to use a mechanism of action different from those of the phosphorus-based antioxidant and the phenol-based antioxidant to contribute to reducing the amount of VOC emitted.

### [Use of Resin Composition]

The resin composition in accordance with an aspect of the present invention has excellent optical characteristics (e.g., luminous transmittance) and emits a smaller amount of VOC. A use of the resin composition in accordance with an aspect of the present invention is not particularly limited. The resin composition in accordance with an aspect of the present invention can be suitably used as a material of a light diffusion member with the aforementioned advantages utilized. For example, in automobile interior parts, the amount of VOC emitted is strictly defined. For this reason, the resin composition in accordance with an aspect of the present invention can be particularly suitably used as, for example, a material of a light diffusion member for an automobile interior. Examples of the light diffusion member include a member that is required to have good light transmissivity, such as a light cover. Thus, the resin composition in accordance with an aspect of the present invention can be a polycarbonate resin composition for light diffusion. Further, the resin composition in accordance with an aspect of the present invention can be suitably used as a composition for use in, for example, a light cover.

### [Polycarbonate Resin]

A type of the polycarbonate resin is not particularly limited provided that the polycarbonate resin is a resin containing a polymer which has a carbonate bond (—O—CO—O—) in the main chain. The polycarbonate resin may be, for example, an aromatic polycarbonate resin or an aliphatic polycarbonate resin. The aromatic polycarbonate resin is a polycarbonate resin that contains an aromatic ring such as a benzene ring between carbonate bonds in the main chain. The aliphatic polycarbonate resin is a polycarbonate resin that does not contain an aromatic ring such as a benzene ring between the carbonate bonds in the main chain. Further, the polycarbonate resin may have a branched structure. One type of polycarbonate resin may be used alone, or two or more types of polycarbonate resins may be used in combination at any ratio.

As the polycarbonate resin, a polycarbonate resin produced by a known method can be used. For example, the polycarbonate resin can be a polycarbonate resin produced by reacting a dihydric phenol with a carbonate precursor by a solution method (interfacial polycondensation method) or a melting method (transesterification method), i.e., a polycarbonate resin produced by an interfacial polycondensation method in which a dihydric phenol is reacted with a phosgene in the presence of an end terminator, or by reacting a dihydric phenol with a diphenyl carbonate, etc. by a transesterification method in the presence of an end terminator.

The dihydric phenol, the carbonate precursor, the end terminator, etc., each of which can be used to produce the polycarbonate resin, can be those ordinarily used in this technical field. For example, a dihydric phenol, a carbonate precursor, an end terminator, etc., that are disclosed in International Publication No. WO 2018/181949 can be used to produce the polycarbonate resin.

In an aspect of the present invention, a viscosity average molecular weight (Mv) of the polycarbonate resin is not limited, but is preferably not less than 10,000 and not more than 30,000, and more preferably not less than 11,000 and not more than 26,000, in terms of fluidity. In particular, in a case where the polycarbonate resin composition in accordance with an aspect of the present invention is used in a light diffusion member (e.g., a light cover, etc.), the Mv of the polycarbonate resin is preferably not less than 12,000 and not more than 25,000, and more preferably not less than 13,000 and not more than 23,000.

In the present specification, a Ubbelohde-type viscometer is used to measure a viscosity of a methylene chloride solution at 20° C., a limiting viscosity [n] is determined from the viscosity, and the viscosity average molecular weight (Mv) is calculated by the following equation:

$$[ η ] = 1.23 \times 10 - 5 {Mv}^{0.83}$$

### (Preferable Type of Polycarbonate Resin)

The polycarbonate resin preferably contains an aromatic polycarbonate resin, the main chain of which has a repeating unit represented by general formula (I):

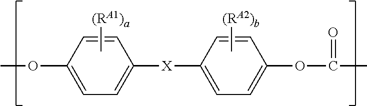

(where
R^{A1} and R^{A2} are each an alkyl group or alkoxy group having 1 to 6 carbon atoms, and RAL and R^{A2} may be the same or different;
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—;
a and b each independently represent an integer of 0 to 4; and
when a is not less than 2, R^{A1} moieties may be the same or different, and when b is not less than 2, R^{A2} moieties may be the same or different).

Examples of alkyl groups represented by R^{A1} and R^{A2} include methyl groups, ethyl groups, n-propyl groups, isopropyl groups, various butyl groups (“various” means containing linear and all branched groups, and the same applies hereinafter), various pentyl groups, and various hexyl groups. Examples of alkoxy groups represented by R^{A1} and R^{A2} include alkoxy groups having the above-listed alkyl groups as alkyl group moieties. R^{A1} and R^{A2} are each preferably an alkyl group having 1 to 4 carbon atoms or an alkoxy group having 1 to 4 carbon atoms.

Examples of the alkylene group represented by X include a methylene group, an ethylene group, a trimethylene group, a tetramethylene group, and a hexamethylene group. The alkylene group represented by X is preferably an alkylene group having 1 to 5 carbon atoms. Examples of the alkylidene group represented by X include an ethylidene group and an isopropylidene group. Examples of the cycloalkylene group represented by X include a cyclopentanediyl group, a cyclohexanediyl group, and a cyclooctanediyl group. The cycloalkylene group represented by X is preferably a cycloalkylene group having 5 to 10 carbon atoms. Examples of the cycloalkylidene group represented by X include a cyclohexylidene group, a 3,5,5-trimethylcyclohexylidene group, and a 2-adamantylidene group. The cycloalkylidene group represented by X is preferably a cycloalkylidene group having 5 to 10 carbon atoms, and more e preferably a cycloalkylidene group having 5 to 8 carbon atoms.

a and b each independently represent an integer of 0 to 4, and are each preferably an integer of 0 to 2, and more preferably 0 or 1.

Examples of the aromatic polycarbonate resin, the main chain of which has a repeating unit represented by general formula (I), include an aromatic polycarbonate resin having a bisphenol A structure (in general formula (I), X is an isopropylidene group).

Specific examples of the aromatic polycarbonate resin having a bisphenol A structure include TARFLON™ (available from FORMOSA IDEMITSU PETROCHEMICAL CORP.).

In an aspect of the present invention, the aromatic polycarbonate resin preferably contains an aromatic polycarbonate resin having a bisphenol A structure, in terms of transparency, mechanical properties, thermal characteristics, etc. of a resulting molded body.

A content of the aromatic polycarbonate resin having a bisphenol A structure in the aromatic polycarbonate resin is not limited, but is preferably not less than 50% by mass and not more than 100% by mass, more preferably not less than 75% by mass and not more than 100% by mass, and even more preferably not less than 85% by mass and not more than 100% by mass because it is possible to sufficiently obtain a desired effect brought about by containing the aromatic polycarbonate resin having a bisphenol A structure.

### [Acrylic Light Diffusion Agent]

The acrylic light diffusion agent is not particularly limited provided that the acrylic light diffusion agent is polymer microparticles containing a polymer which contains a structural unit derived from an acrylic monomer. Examples include methyl(meth)acrylate, of the acrylic monomer ethyl(meth)acrylate, n-propyl(meth)acrylate, isopropyl(meth)acrylate, n-butyl(meth)acrylate, sec-butyl(meth)acrylate, isobutyl(meth)acrylate, tert-butyl(meth)acrylate, n-hexyl(meth)acrylate, 2-ethylhexyl(meth)acrylate, and ethylene glycol dimethacrylate.

In particular, methyl methacrylate is particularly preferable. These acrylic monomers may be of one type or more than one type.

The acrylic light diffusion agent may contain a structural unit derived from a monomer different from an acrylic monomer.

The acrylic light diffusion agent may have a crosslinked structure. One type of acrylic light diffusion agent may be used alone, or two or more types of acrylic light diffusion agents may be used in combination at any ratio.

The acrylic light diffusion agent can contain at least one selected from the group consisting of poly(meth)acrylic particles and crosslinked poly(meth)acrylic particles. As the acrylic light diffusion agent, a known acrylic light diffusion agent can be suitably used, and examples thereof include polymethylmethacrylate (PMMA) particles (product name “GANZPEARL GM-0449S-2” available from Aica Kogyo Co., Ltd.), crosslinked poly(meth)acrylic particles (product name “MBX-5” available from Sekisui Kasei Co., Ltd.), crosslinked poly(meth)acrylic particles (product name “MBX-2H” available from Sekisui Kasei Co., Ltd.), and crosslinked poly(meth)acrylic particles (product name “BMSA-18GN” available from Sekisui Kasei Co., Ltd.).

Preferably not less than 50% by mass, not less than 60% by mass, not less than 70% by mass, not less than 80% by mass, not less than 90% by mass, not less than 95% by mass, not less than 97% by mass, not less than 99% by mass, not less than 99.5% by mass, or substantially 100% by mass of the acrylic light diffusion agent consists of a structural unit derived from a (meth)acrylic monomer.

### (Particle Diameter and Refractive Index of Acrylic Light Diffusion Agent)

A particle diameter of the polymer microparticles contained in the acrylic light diffusion agent is not particularly limited. It is possible to use polymer microparticles having a particle diameter in a range in which the polymer microparticles are ordinarily used as a light diffusion agent. For example, it is possible to use polymer microparticles having a particle diameter of not less than 0.1 μm and not more than 10 μm.

Further, from the viewpoint of a balance between light diffusivity and light transmissivity, the acrylic light diffusion agent is preferably an acrylic light diffusion agent having a refractive index, the difference (i.e., refractive index difference) of which from a refractive index of the polycarbonate resin is not more than 0.13. The refractive index difference is more preferably not more than 0.11. Furthermore, from the viewpoint of a balance between light diffusivity and light transmissivity, the acrylic light diffusion agent may be an acrylic light diffusion agent having a refractive index, the difference of which from a refractive index of the polycarbonate resin is not less than 0.08.

### (Content of Acrylic Light Diffusion Agent)

The resin composition in accordance with an aspect of the present invention contains not less than 0.01 parts by mass and not more than 5 parts by mass of the acrylic light diffusion agent with respect to 100 parts by mass of the polycarbonate resin. In a case where a content of the acrylic light diffusion agent in the resin composition is in the foregoing range, it is possible to sufficiently obtain a light diffusion effect.

From the viewpoint of a balance between light diffusivity and light transmissivity, the content of the acrylic light diffusion agent in the resin composition in accordance with an aspect of the present invention is preferably not less than 0.1 parts by mass, and more preferably not less than 0.5 parts by mass, with respect to 100 parts by mass of the polycarbonate resin. Further, from the same viewpoint, the content of the acrylic light diffusion agent in the resin composition in accordance with an aspect of the present invention is preferably not more than 2.5 parts by mass, and more preferably not more than 2.0 parts by mass, with respect to 100 parts by mass of the polycarbonate resin. From the viewpoint of a balance between light diffusivity and light transmissivity, the content of the acrylic light diffusion agent in the resin composition in accordance with an aspect of the present invention may be not less than 0.6 parts by mass, not less than 0.7 parts by mass, not less than 0.8 parts by mass, not less than 0.9 parts by mass, not less than 1.0 part by mass, not less than 1.1 parts by mass, not less than 1.2 parts by mass, not less than 1.3 parts by mass, not less than 1.4 parts by mass, or not less than 1.5 parts by mass, and not more than 1.5 parts by mass, not more than 1.4 parts by mass, not more than 1.3 parts by mass, not more than 1.2 parts by mass, not more than 1.1 parts by mass, or not more than 1.0 part by mass, with respect to 100 parts by mass of the polycarbonate resin.

### [Phosphorus-Based Antioxidant]

A type of the phosphorus-based antioxidant is not particularly limited. The phosphorus-based antioxidant can be selected from known among phosphorus-based antioxidants as appropriate. Examples of the phosphorus-based antioxidant include a phosphite compound and a phosphine compound. One type of phosphorus-based antioxidant may be used alone, or two or more types of phosphorus-based antioxidants may be used in combination at any ratio.

### (Phosphite Compound)

Examples of the phosphite compound d include a pentaerythritol diphosphite compound and an aryl phosphite compound.

### (Pentaerythritol Diphosphite Compound)

The pentaerythritol diphosphite compound is not particularly limited, and examples thereof include a compound represented by general formula (1):

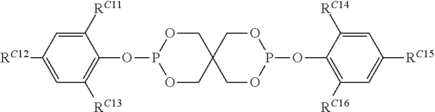

where R^{C11} to R^{C16}
(i) are each a hydrogen atom or an aromatic ring-containing group having 6 to 15 carbon atoms, and may be the same or different, or
(ii) are each a hydrogen atom or an alkyl group having 1 to 12 carbon atoms, and may be the same or different.

Note, however, that not all of R^{C11} to R^{C16} are hydrogen atoms.

In a case where R^{C11} to R^{C16} in formula (1) are (i), examples of the aromatic ring-containing group having 6 to 15 carbon atoms include a phenyl group, a tolyl group, a xylyl group, a naphthyl group, a biphenyl group, a benzyl group, a phenethyl group, a phenylpropyl group, and a cumyl group. These groups each may further have a substituent(s) such as a hydroxyl group and/or an amino group.

In a case where R^{C11} to R^{C16} in formula (1) are (ii), examples of the alkyl group having 1 to 12 carbon atoms include a methyl group, an ethyl group, an n-propyl group, an isopropyl group, various butyl groups, various pentyl groups, various hexyl groups, various octyl groups, various nonyl groups, various decyl groups, various undecyl groups, and various dodecyl groups.

Specific examples of the compound represented by formula (1) include bis(2,4-dicumylphenyl) pentaerythritol diphosphite and bis(2,6-di-tert-butyl-4-methylphenyl) pentaerythritol diphosphite.

### (Preferable Example of Compound Represented by Formula (1))

In a case where R^{C11} to R^{C16} in formula (1) are (i), the aromatic ring-containing group has preferably 6 to 13 carbon atoms, and more preferably 6 to 10 carbon atoms. Examples of an aromatic ring include a benzene ring, a naphthalene ring, a phenanthrene ring, and an anthracene ring, and a benzene ring is preferable.

In particular, the aromatic ring-containing group having 6 to 15 carbon atoms is preferably a group represented by general formula (1a):

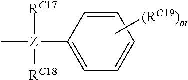

where R^{C17} and R^{C18} are each an alkyl group or an alkenyl group, and may be the same or different. Alternatively, R^{C17} and R^{C18} may be bonded to each other to form a ring. R^{C17} and R^{C18} are each preferably an alkyl group having 1 to 5 carbon atoms or an alkenyl group having 2 to 5 carbon atoms, more preferably an alkyl group having 1 to 3 carbon atoms, and even more preferably a methyl group.

In formula (1a), R^{C19} is a hydrogen atom or an alkyl group, preferably a hydrogen atom or an alkyl group having 1 to 5 carbon atoms, more preferably a hydrogen atom or an alkyl group having 1 to 3 carbon atoms, and even more preferably a hydrogen atom; m is an integer of 0 to 5; and when m is not less than 2, multiple R^{C19} may be the same or different.

In formula (1a), Z represents a single bond or a carbon atom. In a case where Z is a single bond, R^{C17} and R^{C18} are excluded from general formula (1a).

In a case where the compound represented by formula (1) has two or more groups represented by general formula (1a), the two or more groups may be the same or different.

In the compound represented by formula (1), in formula (1), it is preferable that R^{C11} and R^{C14} each be a hydrogen atom and that R^{C12} and R^{C13}, and R^{C15} and R^{C16} each be an aromatic ring-containing group having 6 to 15 carbon atoms, and it is more preferable that R^{C11} and R^{C14} each be a hydrogen atom and that R^{C12} and R^{C13}, and R^{C15} and R^{C16} each be a group represented by general formula (1a).

That is, the compound represented by formula (1) is preferably a pentaerythritol diphosphite compound represented by general formula (1-1):

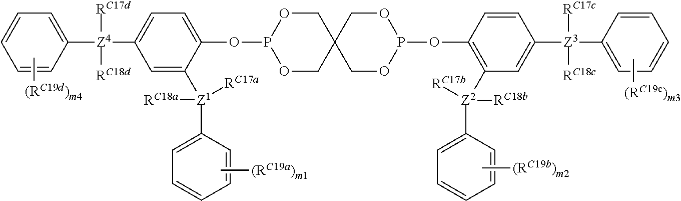

where R^{C17a} to R^{C17d} and R^{C18a} to R^{C18d} are each an alkyl group or an alkenyl group, and may be the same or different. Alternatively, R^{C17a} and R^{C18a}, R^{C17b} and R^{C18b}, R^{C17c} and R^{C18c}, and R^{C17d} and R^{C18d} may be bonded to each other to form a ring.

R^{C19a} to R^{C19d} are each a hydrogen atom or an alkyl group, and may be the same or different.

m1 to m4 are each an integer of 0 to 5, and may be the same or different. When m1 to m4 are each not less than 2, multiple R^{C19a}, R^{C19b}, R^{C19c}, and R^{C19d} may be the same or different.

Z¹ to Z⁴ each represent a single bond or a carbon atom, and may be the same or different. In a case where Z¹ to Z⁴ each represent a single bond, R^{C17a} to R^{C17d} and R^{C18a} to R^{C18d} are excluded from general formula (1-1).

In general formula (1-1), R^{C17a} to R^{C17d} and R^{C18a} to R^{C18d} are each preferably an alkyl group having 1 to 5 carbon atoms or an alkenyl group having 2 to 5 carbon atoms, more preferably an alkyl group having 1 to 3 carbon atoms, and even more preferably a methyl group. It is still more preferable that all of R^{C17a} to R^{C17d} and R^{C18a} to R^{C18d} be methyl groups.

R^{C19a} to R^{C19d} are each preferably a hydrogen atom or an alkyl group having 1 to 5 carbon atoms, more preferably a hydrogen atom or an alkyl group having 1 to 3 carbon atoms, and even more preferably a hydrogen atom. It is still more preferable that all of R^{C19a} to R^{C19d} be hydrogen atoms.

m1 to m4 are each preferably an integer of 0 to 3, more preferably an integer of 0 to 1, and even more preferably 0. Z¹ to Z⁴ are each preferably a carbon atom.

Among pentaerythritol diphosphite compounds represented by general formula (1-1), bis(2,4-dicumylphenyl) pentaerythritol diphosphite represented by formula (1-2) particularly is suitable. Bis(2,4-dicumylphenyl) pentaerythritol diphosphite is available as a commercial product. For example, “Doverphos S-9228PC” available from Dover Chemical Corporation can be used.

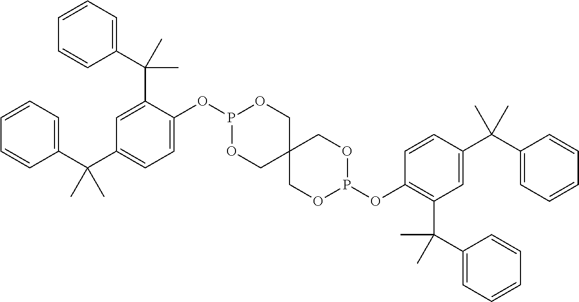 [SMILES: CC(C)(c1ccccc1)c1ccc(OP2OCC3(CO2)COP(Oc2ccc(C(C)(C)c4ccccc4)cc2C(C)(C)c2ccccc2)OC3)c(C(C)(C)c2ccccc2)c1]

In a case where R^{C11} to R^{C16} in formula (1) are (ii), in formula (1), all of R^{C11} to R^{C16} are preferably alkyl groups having 1 to 12 carbon atoms. R^{C11} to R^{C16} are each more preferably at least one selected from the group consisting of a methyl group, an ethyl group, an n-propyl group, an isopropyl group, various butyl groups, various pentyl groups, various hexyl groups, and various octyl groups, and even more preferably at least one selected from the group consisting of a methyl group, an ethyl group, an isopropyl group, and a tert-butyl group.

In particular, the compound represented by formula (1) is more preferably a compound in which R^{C11}, R^{C13}, R^{C14}, and R^{C16} are each a tert-butyl group and in which R^{C12} and R^{C15} are each a methyl group. That is, the compound represented by formula (1) is preferably bis(2,6-di-tert-butyl-4-methylphenyl) pentaerythritol diphosphite represented by formula (1-3). Bis(2,6-di-tert-butyl-4-methylphenyl) pentaerythritol diphosphite is available as a commercial product. For example, “ADK STAB PEP-36” available from ADEKA Corporation can be used.

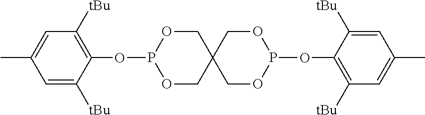

### (Aryl Phosphite Compound)

The aryl phosphite compound is not particularly limited. Examples of the aryl phosphite compound include a compound represented by general formula (2):

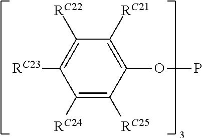

where R^{C21} to R^{C25} are each a hydrogen atom, an alkyl group having 1 to 12 carbon atoms, or an aryl group having 6 to 14 carbon atoms, and may be the same or different. Note, however, that in terms of effectiveness as an antioxidant, not all of R^{C21} to R^{C25} are hydrogen atoms, and at least two of R^{C21} to R^{C25} are each an alkyl group having 1 to 12 carbon atoms or an aryl group having 6 to 14 carbon atoms.

Specific examples of the compound represented by formula (2) include tris(2,4-di-tert-butylphenyl)phosphite.

### (Preferable Example of Compound Represented by Formula (2))

The compound represented by formula (2) is preferably a compound in which in formula (2), any two of R^{C21} to R^{C25} are each an alkyl group having 1 to 12 carbon atoms or an aryl group having 6 to 14 carbon atoms, and the remainder is a hydrogen atom. Among compounds in which any two of R^{C21} to R^{C25} are each an alkyl group having 1 to 12 carbon atoms or an aryl group having 6 to 14 carbon atoms, and the remainder is a hydrogen atom, a compound in which at least one of R^{C21} and R^{C25} is an alkyl group having 1 to 12 carbon atoms or an aryl group having 6 to 14 carbon atoms is more preferable.

Examples of the alkyl group having 1 to 12 carbon atoms include a methyl group, an ethyl group, an n-propyl group, an isopropyl group, various butyl groups, various pentyl groups, various hexyl groups, various octyl groups, various decyl groups, and various dodecyl groups. In particular, at least one selected from the group consisting of a methyl group, an ethyl group, an n-propyl group, an isopropyl group, various butyl groups, various pentyl groups, various hexyl groups, and various octyl groups is preferable, at least one selected from the group consisting of a methyl group, an ethyl group, an isopropyl group, and a tert-butyl group is more preferable, and a tert-butyl group is even more preferable.

Examples of the aryl group having 6 to 14 carbon atoms include a phenyl group, a tolyl group, and a xylyl group.

In particular, R^{C21} to R^{C25} are each more preferably a hydrogen atom or an alkyl group having 1 to 12 carbon atoms, even more preferably a hydrogen atom, a methyl group, an ethyl group, an isopropyl group, or a tert-butyl group, and still more preferably a hydrogen atom or a tert-butyl group. The compound represented by formula (2) is particularly preferably a compound in which R^{C21} and R^{C23} are each a tert-butyl group and in which R^{C22}, R^{C24}, and R^{C25} are each a hydrogen atom, e.g., tris(2,4-di-tert-butylphenyl)phosphite represented by formula (2-1). Tris(2,4-di-tert-butylphenyl)phosphite is available as a commercial product. For example, “IRGAFOS 168” available from BASF can be used.

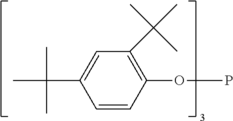

### (Example of Aryl Phosphite Compound Other than Compound Represented by Formula (2))

Other examples of the aryl phosphite compound include a compound represented by general formula (3) and a compound represented by general formula (4).

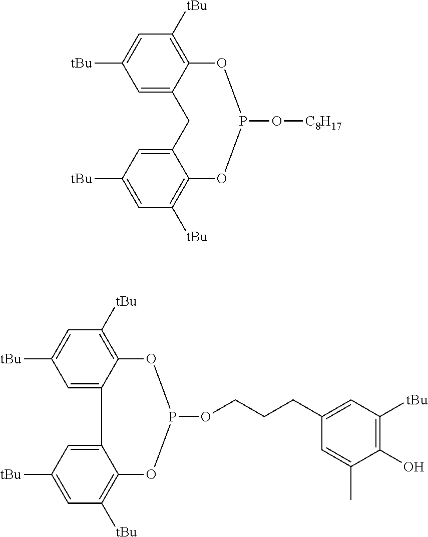

The compound represented by formula (3) is 2,2′-methylenebis(4,6-di-tert-butylphenyl) 2-ethylhexyl phosphite. 2,2′-methylenebis(4,6-di-tert-butylphenyl) 2-ethylhexyl phosphite is available as a commercial product. For example, “ADK STAB HP-10” available from ADEKA Corporation can be used.

The compound represented by formula (4) is 2-tert-butyl-6-methyl-4-{3-[(2,4,8,10-tetra-tert-butyldibenzo[d,f][1,3,2] dioxaphosphepine-6-yl)oxy]propyl}phenol. 2-tert-butyl-6-methyl-4-{3-[(2,4,8,10-tetra-tert-butyldibenzo[d,f][1,3,2] dioxaphosphepine-6-yl)oxy]propyl} phenol is available as a commercial product. For example, “Sumilizer GP” available from Sumitomo Chemical Co., Ltd. can be used.

### (Phosphine Compound)

Examples of the phosphine compound include an aryl phosphine compound.

The aryl phosphine compound need only be a phosphine compound having at least one aryl group, and examples thereof include a compound represented by general formula (5):

P—(R^{D21})₃ (5)
where R^{D21} is a hydrocarbon group that may have a substituent, and at least one R^{D21} is an aryl group having 6 to 18 carbon atoms. Multiple R^{D21} may be the same or different.

Examples of the compound represented by general formula (5) include triphenylphosphine, diphenylbutylphosphine, diphenyloctadecylphosphine, tris(p-tolyl)phosphine, tris(p-nonylphenyl)phosphine, tris(naphthyl)phosphine, diphenyl(hydroxymethyl)phosphine, diphenyl(acetoxymethyl)phosphine, diphenyl(β-ethylcarboxyethyl)phosphine, tris(p-chlorophenyl)phosphine, tris(p-fluorophenyl)phosphine, diphenylbenzylphosphine, diphenyl-β-cyanoethylphosphine, diphenyl(p-hydroxyphenyl)phosphine, diphenyl-1,4-dihydroxyphenyl-2-phosphine, and phenylnaphthyl benzylphosphine.

### (Preferable Example of Compound Represented by Formula (5))

In particular, a compound in which R^{D21} moieties in general formula (5) are all aryl groups is preferable, and triphenylphosphine is more preferable. Triphenylphosphine is available as a commercial product. For example, “JC-263” available from Johoku Chemical Industry Co., Ltd. can be used.

### (Preferable Type of Phosphorus-Based Antioxidant)

The phosphorus-based antioxidant is preferably at least one selected from the group consisting of a phosphite compound and a phosphine compound, and more preferably contains at least a phosphite compound. In particular, the phosphorus-based antioxidant preferably contains at least one selected from the group consisting of the compound represented by general formula (1), the compound represented by general formula (2), and the compound represented by general formula (3), more preferably contains at least one selected from the group consisting of the pentaerythritol diphosphite compound represented by general formula (1-1) and the compound represented by general formula (2), and even more preferably contains at least one selected from the group consisting of the pentaerythritol diphosphite compound represented by general formula (1-1) and tris(2,4-di-tert-butylphenyl)phosphite represented by general formula (2-1). The phosphorus-based antioxidant more preferably contains at least one selected from the group consisting of: tris(2,4-di-tert-butylphenyl)phosphite; bis(2,4-dicumylphenyl) pentaerythritol diphosphite; bis(2,6-di-tert-butyl-4-methylphenyl) pentaerythritol diphosphite; and 2,2′-methylenebis(4,6-di-tert-butylphenyl) 2-ethylhexyl phosphite.

### (Content of Phosphorus-Based Antioxidant)

The resin composition in accordance with an aspect of the present invention contains not less than 0.005 parts by mass and not more than 2 parts by mass of the phosphorus-based antioxidant with respect to 100 parts by mass of the polycarbonate resin. In a case where a content of the phosphorus-based antioxidant in the resin composition is in the foregoing range, it is possible to sufficiently obtain an effect of further reducing the amount of VOC emitted.

The content of the phosphorus-based antioxidant in the resin composition in accordance with an aspect of the present invention is preferably not less than 0.05 parts by mass, more preferably not less than 0.1 parts by mass, and particularly preferably not less than 0.2 parts by mass, with respect to 100 parts by mass of the polycarbonate resin. Further, the content of the phosphorus-based antioxidant in the resin composition in accordance with an aspect of the present invention is preferably not more than 1.0 part by mass, and more preferably not more than 0.5 parts by mass, with respect to 100 parts by mass of the polycarbonate resin.

### [Phenol-Based Antioxidant]

A type of the phenol-based antioxidant is not particularly limited. The phenol-based antioxidant can be selected from among known phenol-based antioxidants as appropriate. As the phenol-based antioxidant, at least one selected from the group consisting of a hindered phenol-based antioxidant, a semi-hindered phenol-based antioxidant, and a less hindered phenol-based antioxidant is suitably used. One type of phenol-based antioxidant may be used alone, or two or more types of phenol-based antioxidants may be used in combination at any ratio.

Examples of the hindered phenol-based antioxidant include: n-octadecyl-3-(3,5-di-t-butyl-4-hydroxyphenyl) propionate (e.g., product name “Irganox 1076” available from BASF Japan Ltd., or product name “ADK STAB AO-50” available from ADEKA Corporation); pentaerythrithyl-tetrakis[3-(3,5-di-t-butyl-4-hydroxyphenyl) propionate] (e.g., product name “Irganox 1010” available from BASF Japan Ltd., or product name “ADK STAB AO-60” available from ADEKA Corporation); N,N′-hexamethylenebis [3-(3,5-di-t-butyl-4-hydroxyphenyl) propionamide] (e.g., product name “Irganox 1098” available from BASF Japan Corporation); and 2,2-thio-diethylene bis [3-(3,5-di-t-butyl-4-hydroxyphenyl) propionate] (e.g., product name “Irganox 1035” available from BASF Japan Corporation).

Examples of the semi-hindered phenol-based antioxidant include 3,9-bis[2-[3-(3-t-butyl-4-hydroxy-5-methylphenyl) propionyloxy]-1,1-dimethylethyl]-2,4,8,10-tetraoxaspiro[5.5]undecane (e.g., product name “Sumilizer GA-80” available from Sumitomo Chemical Co., Ltd., or product name “ADK STAB AO-80” available from ADEKA Corporation).

Examples of the less hindered phenol-based antioxidant include: 4,4′,4″-(1-methylpropanyl-3-ylidene)tris(6-tert-butyl-m-cresol) (e.g., product name “ADK STAB AO-30” available from ADEKA Corporation); and 6,6′-di-tert-butyl-4,4′-butylidene di-m-cresol (e.g., product name “ADK STAB AO-40” available from ADEKA Corporation).

### (Preferable Type of Phenol-Based Antioxidant)

The phenol-based antioxidant preferably contains the hindered phenol-based antioxidant. Examples of the hindered phenol-based antioxidant are as listed above. Among these, the hindered phenol-based antioxidant preferably contains at least one selected from the group consisting of: n-octadecyl-3-(3,5-di-t-butyl-4-hydroxyphenyl) propionate; and pentaerythrithyl-tetrakis[3-(3,5-di-t-butyl-4-hydroxyphenyl) propionate].

### (Content of Phenol-Based Antioxidant)

The resin composition in accordance with an aspect of the present invention contains not less than 0.005 parts by mass and not more than 2 parts by mass of the phenol-based antioxidant with respect to 100 parts by mass of the polycarbonate resin. In a case where a content of the phenol-based antioxidant in the resin composition is in the foregoing range, it is possible to sufficiently obtain an effect of further reducing the amount of VOC emitted.

The content of the phenol-based antioxidant in the resin composition in accordance with an aspect of the present invention is preferably not less than 0.01 parts by mass, more preferably not less than 0.05 parts by mass, and particularly preferably not less than 0.1 parts by mass, with respect to 100 parts by mass of the polycarbonate resin. Further, the content of the phenol-based antioxidant in the resin composition in accordance with an aspect of the present invention is preferably not more than 0.3 parts by mass, and more preferably not more than 0.2 parts by mass, with respect to 100 parts by mass of the polycarbonate resin.

### [Alicyclic Epoxy Compound]

The alicyclic epoxy compound refers to a cyclic aliphatic compound having an alicyclic epoxy group, i.e., an epoxy group obtained by adding one oxygen atom to an ethylene bond in an aliphatic ring. A type of the alicyclic epoxy compound is not particularly limited and can be selected as appropriate.

Examples of the alicyclic epoxy compound include (i) a compound which has an alicyclic epoxy group in a molecule and (ii) a compound in which an epoxy is bonded directly by a single bond to an alicyclic ring. Note here that the “alicyclic epoxy group” refers to an epoxy group constituted by two adjacent carbon atoms and an oxygen atom which constitute an alicyclic ring. Examples of the “compound which has an alicyclic epoxy group in a molecule” include a compound which has a cyclopentene oxide group and a compound which has a cyclohexene oxide group.

As the alicyclic epoxy compound, for example, alicyclic epoxy compounds represented by formulas (B-1) to (B-10) are suitably used.

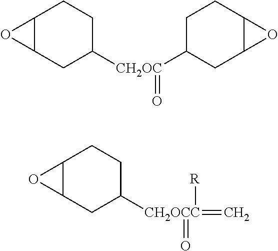

(where R is H or CH₃.)

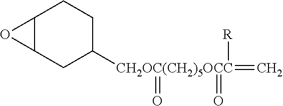

(where R is H or CH₃.)

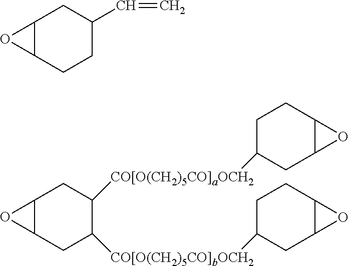

(where a+b=1 or 2.)

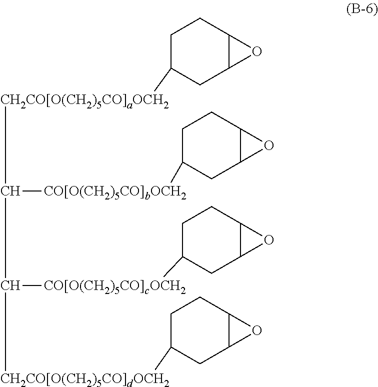

(where a+b+c+d=1, 2, or 3.)

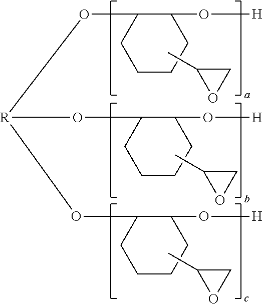

(where a+b+c=n (an integer), and R is a hydrocarbon group.)

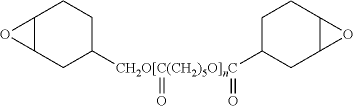

(where n is an integer.)

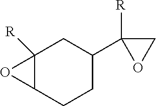

(where R is a hydrocarbon group.)

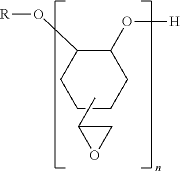

(where n is an integer, and R is a hydrocarbon group.)

The alicyclic epoxy compounds represented by formulas (B-1) to (B-6) and (B-8) are examples of the “compound which has a cyclohexene oxide group”. The alicyclic epoxy compounds represented by formulas (B-7), (B-9), and (B-10) are examples of the “compound in which an epoxy is bonded directly by a single bond to an alicyclic ring”.

One type of alicyclic epoxy compound may be used alone, or two or more types of alicyclic epoxy compounds may be used in combination at any ratio.

### (Preferable Type of Alicyclic Epoxy Compound)

The alicyclic epoxy compound is preferably at least one selected from the group consisting of the compounds represented by formulas (B-1) and (B-10), and more preferably the compound represented by formula (B-1). This is because such an alicyclic epoxy compound has excellent compatibility with a polycarbonate resin and does not compromise transparency.

For example, the compound represented by formula (B-1) is 3′,4′-epoxycyclohexylmethyl-3,4-epoxycyclohexanecarboxylate, which is commercially available under the product name of “CELLOXIDE 2021P” (available from Daicel Corporation).

Examples of the compound represented by formula (B-10) include a 1,2-epoxy-4-(2-oxiranyl)cyclohexane adduct of 2,2-bis(hydroxymethyl)-1-butanol, which is commercially available under the product name of “EHPE 3150” (available from Daicel Corporation).

As a mixture of CELLOXIDE 2021P and EHPE 3150, “EHPE 3150 CE”, which is the product name and which is commercially available from Daicel Corporation, can also be preferably used.

Thus, the alicyclic epoxy compound preferably contains 3′,4′-epoxycyclohexylmethyl-3,4-epoxycyclohexanecarboxylate.

In addition to the above-listed alicyclic epoxy compounds, bi-7-oxabicyclo[4.1.0]heptane can also be preferably used. Bi-7-oxabicyclo[4.1.0]heptane is commercially available under the product name of “CELLOXIDE 8010” (available from Daicel Corporation).

### (Content of Alicyclic Epoxy Compound)

The resin composition in accordance with an aspect of the present invention contains not less than 0.001 parts by weight and not more than 5 parts by weight of the alicyclic epoxy compound with respect to 100 parts by mass of the polycarbonate resin. In a case where a content of the alicyclic epoxy compound in the resin composition is in the foregoing range, it is possible to sufficiently obtain an effect of further reducing the amount of VOC emitted.

The content of the alicyclic epoxy compound in the resin composition in accordance with an aspect of the present invention is preferably not less than 0.005 parts by mass, more preferably not less than 0.01 parts by mass, even more preferably not less than 0.02 parts by mass, and particularly preferably not less than 0.03 parts by mass, with respect to 100 parts by mass of the polycarbonate resin. Further, the content of the alicyclic epoxy compound in the resin composition in accordance with an aspect of the present invention is preferably not more than 0.2 parts by mass, more preferably less than 0.1 parts by mass, more preferably not more than 0.09 parts by mass, and even more preferably not more than 0.05 parts by mass, with respect to 100 parts by mass of the polycarbonate resin.

### [Other Components]

With the resin composition in accordance with an aspect of the present invention, optional additives such as an ultraviolet absorber and a release agent in addition to the foregoing components can be mixed provided that the effect of the present invention is not hindered. An additive can be a common additive that is ordinarily used in this technical field.

For example, in a case where the ultraviolet absorber is added, an addition amount of the ultraviolet absorber in the resin composition in accordance with an aspect of the present invention can be not less than 0.001 parts by mass and not more than 3 parts by mass with respect to 100 parts by mass of the polycarbonate resin. In a case where a content of the ultraviolet absorber in the resin composition is in the foregoing range, sufficient weather resistance can be imparted to the resin composition.

For example, in a case where the release agent is added, an addition amount of the release agent in the resin composition in accordance with an aspect of the present invention can be not less than 0.001 parts by mass and not more than 3 parts by mass with respect to 100 parts by mass of the polycarbonate resin. In a case where a content of the release agent in the resin composition is in the foregoing range, releasability can be improved, and mold deposits can be greatly reduced even under continuous molding conditions.

### [Method for Producing Polycarbonate Resin Composition]

A method for producing the resin composition in accordance with an aspect of the present invention is not particularly limited. The resin composition in accordance with an aspect of the present invention can be produced by a known method. For example, the resin composition in accordance with an aspect of the present invention can be produced by mixing the foregoing components at normal temperature (e.g., 20° C. to 30° C.) and then melt-kneading a resulting mixture. Melt-kneading can be carried out by a method that is ordinarily used in this technical field, such as a method in which a single-screw extruder, a twin-screw extruder, a co-kneader, a multi-screw extruder, or the like is used. A heating temperature during melt-kneading is ordinarily selected, as appropriate, in a range of 220° C. to 300° C.

### <2. Molded Body>

A molded body containing the polycarbonate resin composition in accordance with an aspect of the present invention is also encompassed in the scope of the present invention. The polycarbonate resin composition in accordance with an aspect of the present invention of a molded body in accordance with an aspect of the present invention is as already described, and thus a description thereof is omitted here.

### [Method for Producing Molded Body]

The molded body in accordance with an aspect of the present invention can be produced by a production method including a molding step of molding the polycarbonate resin composition in accordance with an aspect of the present invention. In the molding step, a method for molding the polycarbonate resin composition in accordance with an aspect of the present invention is not particularly limited. For example, a melt-kneaded product of the polycarbonate resin composition in accordance with an aspect of the present invention or a pellet obtained through melt-kneading can be used as a raw material to produce the molded body in accordance with an aspect of the present invention by any of known molding methods such as an injection molding method, an injection compression molding method, an extrusion molding method, a blow molding method, a press molding method, a vacuum molding method, and a foam molding method. In particular, the obtained pellet is preferably used to produce the molded body by the injection molding method or the injection compression molding method. A molding temperature in the molding step is not particularly limited. The molding temperature can be set as appropriate, and molding can be carried out at, for example, a temperature of 240° C. to 300° C.

### [Use of Molded Body]

The molded body in accordance with an aspect of the present invention has excellent optical characteristics (e.g., luminous transmittance) and emits a smaller amount of VOC. A use of the molded body in accordance with an aspect of the present invention is not particularly limited. The molded body in accordance with an aspect of the present invention can be suitably used as a light diffusion member with the aforementioned advantages utilized. For example, in automobile interior parts, the amount of VOC emitted is strictly defined. For this reason, the molded body in accordance with an aspect of the present invention can be particularly suitably used as, for example, a light diffusion member for an automobile interior. Thus, the molded body in accordance with an aspect of the present invention can be a light diffusion member for an automobile interior. Examples of the light diffusion member include a member that is required to have good light transmissivity, such as a light cover. For this reason, the molded body in accordance with an aspect of the present invention can be suitably used as a light cover. Thus, the molded body in accordance with an aspect of the present invention is a light cover.

Aspects of the present invention can also be expressed as follows:

A polycarbonate resin composition in accordance with Aspect 1 of the present invention is configured to contain, with respect to 100 parts by mass of a polycarbonate resin, not less than 0.01 parts by mass and not more than 5 parts by mass of an acrylic light diffusion agent, not less than 0.005 parts by mass and not more than 2 parts by mass of a phosphorus-based antioxidant, not less than 0.005 parts by mass and not more than 2 parts by mass of a phenol-based antioxidant, and not less than 0.001 parts by weight and not more than 5 parts by weight of an alicyclic epoxy compound.

In Aspect 2 of the present invention, a polycarbonate resin composition is preferably configured such that, in Aspect 1, the polycarbonate resin composition contains not less than 0.005 parts by mass and not more than 0.2 parts by mass of the alicyclic epoxy compound with respect to 100 parts by mass of the polycarbonate resin.

In Aspect 3 of the present invention, a polycarbonate resin composition is preferably configured such that, in Aspect 1 or 2, the alicyclic epoxy compound contains at least one selected from the group consisting of 3′,4′-epoxycyclohexylmethyl-3,4-epoxycyclohexanecarboxylate and bi-7-oxabicyclo[4.1.0]heptane.

In Aspect 4 of the present invention, a polycarbonate resin composition is preferably configured such that, in any one of Aspects 1 to 3, the polycarbonate resin contains an aromatic polycarbonate resin, the main chain of which has a repeating unit represented by general formula (I):

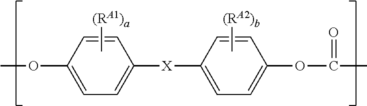

(where
R^{A1} and R^{A2} are each an alkyl group or alkoxy group having 1 to 6 carbon atoms, and R^{A1} and R^{A2} may be the same or different;
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—;
a and b each independently represent an integer of 0 to 4;
and
when a is not less than 2, R^{A1} moieties may be the same or different, and when b is not less than 2, R^{A2} moieties may be the same or different).

In Aspect 5 of the present invention, a polycarbonate resin composition is preferably configured such that, in any one of Aspects 1 to 4, the polycarbonate resin has a viscosity average molecular weight of not less than 10,000 and not more than 30,000.

In Aspect 6 of the present invention, a polycarbonate resin composition is preferably configured such that, in any one of Aspects 1 to 5, the acrylic light diffusion agent contains at least one selected from the group consisting of poly(meth)acrylic particles and crosslinked poly(meth)acrylic particles.

In Aspect 7 of the present invention, a polycarbonate resin composition is preferably configured such that, in any one of Aspects 1 to 6, a refractive index difference between the polycarbonate resin and the acrylic light diffusion agent is not more than 0.11.

In Aspect 8 of the present invention, a polycarbonate resin composition is preferably configured such that, in any one of Aspects 1 to 7, the phosphorus-based antioxidant contains a phosphite compound.

In Aspect 9 of the present invention, a polycarbonate resin composition is preferably configured such that, in any one of Aspects 1 to 8, the phosphorus-based antioxidant contains at least one selected from the group consisting of: tris(2,4-di-tert-butylphenyl)phosphite; bis(2,4-dicumylphenyl) pentaerythritol diphosphite; bis(2,6-di-tert-butyl-4-methylphenyl) pentaerythritol diphosphite; and 2,2′-methylenebis(4,6-di-tert-butylphenyl)2-ethylhexyl phosphite.

In Aspect 10 of the present invention, a polycarbonate resin composition is preferably configured such that, in any one of Aspects 1 to 9, the phenol-based antioxidant contains at least one selected from the group consisting of a hindered phenol-based antioxidant, a semi-hindered phenol-based antioxidant, and a less hindered phenol-based antioxidant.

In Aspect 11 of the present invention, a polycarbonate resin composition is preferably configured such that, in any one of Aspects 1 to 10, the phenol-based antioxidant contains the hindered phenol-based antioxidant.

In Aspect 12 of the present invention, a polycarbonate resin composition is preferably configured such that, in any one of Aspects 1 to 11, the polycarbonate resin composition is a polycarbonate resin composition for light diffusion.

A molded body in accordance with Aspect 13 of the present invention is configured to contain a polycarbonate resin composition described in any one of Aspects 1 to 12.

In Aspect 14 of the present invention, a molded body can be configured such that, in Aspect 13, the molded body is a light cover.

In Aspect 15 of the present invention, a molded body can be configured such that, in Aspect 13, the molded body is a light diffusion member for an automobile interior.

The present invention is not limited to the embodiments above, but can be altered in various ways within the scope of the claims. The present invention also encompasses, in its technical scope, any embodiment derived by properly combining technical means disclosed in differing embodiments.

### EXAMPLES

The following description will discuss the present invention in more detail with reference to Examples and Comparative Examples. However, the present invention is not limited to these Examples.

### <Raw Materials of Polycarbonate Resin Composition>

Raw materials of polycarbonate resin compositions used in Examples and Comparative Examples are as below.

### (Polycarbonate Resin)

Product name “TARFLON™ FN1700” (bisphenol A polycarbonate resin available from FORMOSA IDEMITSU PETROCHEMICAL CORP. and having a viscosity average molecular weight (Mv) of 17,700 and a refractive index of 1.585)

### (Acrylic Light Diffusion Agent)

Product name “GANZPEARL GM-0449S-2” (polymethylmethacrylate (PMMA) particles available from Aica Kogyo Co., Ltd. and having an average particle diameter of 4 μm, a refractive index of 1.49, and a refractive index difference of 0.095)

### (Phosphorus-Based Antioxidant)

The following two types of phosphorus-based antioxidants were used:
Product name: “IRGAFOS 168” (tris(2,4-di-tert-butylphenyl)phosphite available from BASF); and
Product name: “Doverphos S-9228PC” (bis(2,4-dicumylphenyl) pentaerythritol diphosphite available from Dover Chemical Corporation)

### (Phenol-Based Antioxidant)

Product name “Irganox 1076” (n-octadecyl-3-(3,5-di-t-butyl-4-hydroxyphenyl) propionate available from BASF Japan Ltd.)

### (Alicyclic Epoxy Compound)

Product name: “CELLOXIDE 2021P” (3′,4′-epoxycyclohexylmethyl-3,4-epoxycyclohexanecarboxylate available from Daicel Corporation)

### (Alicyclic Epoxy Compound)

Product name: “CELLOXIDE 8010” (bi-7-oxabicyclo[4.1.0]heptane available from Daicel Corporation)

### (Other Additive: Ultraviolet Absorber)

Product name “KEMISORB 79” (2-(2-hydroxy-5-tert-octylphenyl)-2H-benzotriazole available from Chemipro Kasei Kaisha, Ltd.)

### (Other Additive: Release Agent)

Product name “EW-440A” (pentaerythritol tetrasterate available from Riken Vitamin Co., Ltd.).

### Example 1

Components were mixed in accordance with mixing ratios shown in Table 1, so that a polycarbonate resin composition of Example 1 was obtained. A vented twin-screw extruder having a screw diameter of 37 mm (“TEM-37SS” available from SHIBAURA MACHINE CO., LTD.) was used to melt-knead the polycarbonate resin composition at a cylinder temperature of 280° C., and a pellet was obtained by strand cutting. The obtained pellet was dried at 120° C. for 5 hours.

An injection molding machine (“MD50XB” available from Niigata Machinery Co., LTD.) was used to mold the dried pellet, by an injection molding method and at a cylinder temperature of 300° C., a die temperature of 80° C., and a cycle time of 40 seconds, into a three-step test piece (molded body) illustrated in The FIGURE. The FIGURE is a perspective view illustrating an appearance of a molded body produced in Examples. The size of the molded body illustrated in The FIGURE is as below.

Thickness H₁: 3 mm, H₂: 2 mm, H₃: 1 mm Length L in long direction L₁: 44 mm, L₂: 23 mm, L₃: 23 mm Length W in short direction: W₁: 50 mm

### Examples 2 to 6 and Comparative Examples 1 to 5

Test pieces of Examples 2 to 6 and Comparative Examples 1 to 5 were produced in the same manner as in Example 1, except that components were mixed in accordance with mixing ratios shown in Table 1 or 2.

### <VOC Content Measurement Test>

The amount of VOC emitted from each of the test pieces of Examples 1 to 6 and Comparative Examples 1 to 5 was measured by the following method.

### (Measurement of Total Volatile: Organic Compounds (TVOCs))

Measurement was carried out by a headspace gas chromatography method in accordance with the VW standard PV3341. Measurement conditions are as shown below.
Headspace sampler: 7697A available from Agilent Technologies
GC system: 78909B available from Agilent Technologies
Column: DB-HeavyWAX (30 m×0.25 mm×0.25 μm)
Oven temperature: 120° C.
Vial equilibration time: 5 hours
Injection port temperature: 200° C.
Detector (FID) temperature: 260° C.

A sample for use in TVOC measurement was placed in an aluminum (AL) bag that can be sealed after molding, and was stored in a room temperature (20° C. to 25° C.) environment until measurement. 2 g of the sample was cut out from a thinner end of a molded article (three-step test piece) and used.

### Results

Tables 1 and 2 show results.

TABLE 1

| | | | Exam- | Exam- | Exam- | Exam- | Exam- | Exam- |
|---|---|---|---|---|---|---|---|---|
| | | | ple | ple | ple | ple | ple | ple |
| | | | 1 | 2 | 3 | 4 | 5 | 6 |
| Polycarbonate resin | TARFLON ™ FN1700 | phr | 100.00 | 100.00 | 100.00 | 100.00 | 100.00 | 100.00 |
| Phosphorus-based | IRGAFOS 168 | phr | 0.15 | 0.15 | 0.15 | 0.15 | 0.15 | 0.15 |
| antioxidant | Doverphos S-9228PC | phr | 0.05 | 0.05 | 0.05 | 0.05 | 0.05 | 0.05 |
| Phenol-based antioxidant | Irganox 1076 | phr | 0.05 | 0.05 | 0.05 | 0.05 | 0.05 | 0.05 |
| Total of antioxidants | | | 0.25 | 0.25 | 0.25 | 0.25 | 0.25 | 0.25 |
| Acrylic light | GANZPEARL | phr | 1.1 | 1.1 | 1.1 | 1.1 | 1.1 | 1.1 |
| diffusion agent | GM-0449S-2 | | | | | | | |
| Alicyclic epoxy compound | CELLOXIDE 2021P | phr | 0.01 | 0.03 | 0.10 | 0.20 | 0.00 | 0.00 |
| Alicyclic epoxy compound | CELLOXIDE 8010 | phr | 0.00 | 0.00 | 0.00 | 0.00 | 0.03 | 0.10 |
| Ultraviolet absorber | KEMISORB 79 | phr | 0.30 | 0.30 | 0.30 | 0.30 | 0.30 | 0.30 |
| Release agent | EW-440A | phr | 0.30 | 0.30 | 0.30 | 0.30 | 0.30 | 0.30 |

| | | | | | | | |
|---|---|---|---|---|---|---|---|
| Amount of VOC emitted | μg C/g | 10.6 | 9.4 | 10.9 | 10.3 | 9.9 | 10.1 |

TABLE 2

| | | | Com- | Com- | Com- | Com- | Com- |
|---|---|---|---|---|---|---|---|
| | | | parative | parative | parative | parative | parative |
| | | | Exam- | Exam- | Exam- | Exam- | Exam- |
| | | | ple | ple | ple | ple | ple |
| | | | 1 | 2 | 3 | 4 | 5 |
| Polycarbonate resin | TARFLON ™ FN1700 | phr | 100.00 | 100.00 | 100.00 | 100.00 | 100.00 |
| Phosphorus-based | IRGAFOS 168 | phr | 0.15 | 0.15 | 0.15 | 0.20 | 0.00 |
| antioxidant | Doverphos S-9228PC | phr | 0.05 | 0.05 | 0.00 | 0.00 | 0.00 |
| Phenol-based antioxidant | Irganox 1076 | phr | 0.05 | 0.00 | 0.00 | 0.00 | 0.05 |
| Total of antioxidants | | | 0.25 | 0.20 | 0.15 | 0.20 | 0.05 |
| Acrylic light diffusion agent | GANZPEARL GM-0449S-2 | phr | 1.1 | 1.1 | 1.1 | 1.1 | 1.1 |
| Alicyclic epoxy compound | CELLOXIDE 2021P | phr | 0.00 | 0.10 | 0.00 | 0.00 | 0.00 |
| Alicyclic epoxy compound | CELLOXIDE 8010 | phr | 0.00 | 0.00 | 0.00 | 0.00 | 0.00 |
| Ultraviolet absorber | KEMISORB 79 | phr | 0.30 | 0.30 | 0.30 | 0.30 | 0.30 |
| Release agent | EW-440A | phr | 0.30 | 0.30 | 0.30 | 0.30 | 0.30 |

| | | | | | | |
|---|---|---|---|---|---|---|
| Amount of VOC emitted | μg C/g | 12.7 | 13.5 | 14.5 | 14.9 | 23.6 |

Since the phosphorus-based antioxidant had a greater effect of further reducing the amount of VOC emitted than the phenol-based antioxidant, it has been considered that the phosphorus-based antioxidant is a main agent in reducing the amount of VOC emitted. However, only any one component or a combination of two components among three components, which are the phosphorus-based antioxidant, the phenol-based antioxidant, and the alicyclic epoxy compound, had a small effect of reducing the amount of VOC emitted. It has been shown that combining and mixing three components, which are the phosphorus-based antioxidant, the phenol-based antioxidant, and the alicyclic epoxy compound, tends to make it possible to further reduce the amount of VOC emitted.

The above results have shown that a polycarbonate resin composition containing, with respect to 100 parts by mass of a polycarbonate resin, not less than 0.01 parts by mass and not more than 5 parts by mass of an acrylic light diffusion agent, not less than 0.005 parts by mass and not more than 2 parts by mass of a phosphorus-based antioxidant, not less than 0.005 parts by mass and not more than 2 parts by mass of a phenol-based antioxidant, and not less than 0.001 parts by weight and not more than 5 parts by weight of an alicyclic epoxy compound emits a smaller amount of VOC.

### INDUSTRIAL APPLICABILITY

A polycarbonate resin composition in accordance with an aspect of the present invention can be suitably used as a light diffusion resin composition.

### REFERENCE SIGNS LIST

H₁, H₂, H₃ Thickness
L₁, L₂, L₃ Length in long direction
W₁ Length in short direction

1. A polycarbonate resin composition comprising, with respect to 100 parts by mass of a polycarbonate resin,
not less than 0.01 parts by mass and not more than 5 parts by mass of an acrylic light diffusion agent,
not less than 0.005 parts by mass and not more than 2 parts by mass of a phosphorus-based antioxidant,
not less than 0.005 parts by mass and not more than 2 parts by mass of a phenol-based antioxidant, and
not less than 0.001 parts by weight and not more than 5 parts by weight of an alicyclic epoxy compound.

2. The polycarbonate resin composition as set forth in claim 1, wherein the polycarbonate resin composition contains not less than 0.005 parts by mass and not more than 0.2 parts by mass of the alicyclic epoxy compound with respect to 100 parts by mass of the polycarbonate resin.

3. The polycarbonate resin composition as set forth in claim 1, wherein the alicyclic epoxy compound contains at least one selected from the group consisting of 3′,4′-epoxycyclohexylmethyl-3,4-epoxycyclohexanecarboxylate and bi-7-oxabicyclo[4.1.0]heptane.

4. The polycarbonate resin composition as set forth in claim 1, wherein the polycarbonate resin contains an aromatic polycarbonate resin, the main chain of which has a repeating unit represented by general formula (I): 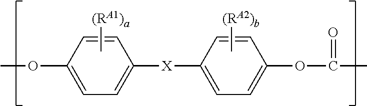
(where
R^{A1} and R^{A2} are each an alkyl group or alkoxy group having 1 to 6 carbon atoms, and RAI and R^{A2} may be the same or different;
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—;
a and b each independently represent an integer of 0 to 4; and
when a is not less than 2, R^{A1} moieties may be the same or different, and when b is not less than 2, R^{A2} moieties may be the same or different).

5. The polycarbonate resin composition as set forth in claim 1, wherein the polycarbonate resin has a viscosity average molecular weight of not less than 10,000 and not more than 30,000.

6. The polycarbonate resin composition as set forth in claim 1, wherein the acrylic light diffusion agent contains at least one selected from the group consisting of poly(meth)acrylic particles and crosslinked poly(meth)acrylic particles.

7. The polycarbonate resin composition as set forth in claim 1, wherein a refractive index difference between the polycarbonate resin and the acrylic light diffusion agent is not more than 0.11.

8. The polycarbonate resin composition as set forth in claim 1, wherein the phosphorus-based antioxidant contains a phosphite compound.

9. The polycarbonate resin composition as set forth in claim 8, wherein the phosphorus-based antioxidant contains at least one selected from the group consisting of: tris(2,4-di-tert-butylphenyl)phosphite; bis(2,4-dicumylphenyl) pentaerythritol diphosphite; bis(2,6-di-tert-butyl-4-methylphenyl) pentaerythritol diphosphite; and 2,2′-methylenebis(4,6-di-tert-butylphenyl) 2-ethylhexyl phosphite.

10. The polycarbonate resin composition as set forth in claim 1, wherein the phenol-based antioxidant contains at least one selected from the group consisting of a hindered phenol-based antioxidant, a semi-hindered phenol-based antioxidant, and a less hindered phenol-based antioxidant.

11. The polycarbonate resin composition as set forth in claim 10, wherein the phenol-based antioxidant contains the hindered phenol-based antioxidant.

12. The polycarbonate resin composition as set forth in claim 1, wherein the polycarbonate resin composition is a polycarbonate resin composition for light diffusion.

13. A molded body comprising a polycarbonate resin composition recited in claim 1.

14. The molded body as set forth in claim 13, wherein the molded body is a light cover.

15. The molded body as set forth in claim 13, wherein the molded body is a light diffusion member for an automobile interior.
